(19) United States
(12) Patent Application Publication
(10) Pub. No.: US 2023/0055958 A1
(43) Pub. Date: Feb. 23, 2023

(54) Systems and Methods to Repossess a Vehicle

(71) Applicant: Ford Global Technologies, LLC, Dearborn, MI (US)

(72) Inventors: Anthony Maraldo, Southgate, MI (US); Brendan Diamond, Grosse Pointe, MI (US); Keith Weston, Canton, MI (US); Michael Alan Mcnees, Flat Rock, MI (US)

(73) Assignee: Ford Global Technologies, LLC, Dearborn, MI (US)

(21) Appl. No.: 17/408,004

(22) Filed: Aug. 20, 2021

(51) Int. Cl. G06Q 20/10; G06Q 20/42; G06Q 30/06; B60R 25/20; B60R 25/10; B60W 60/00

(52) U.S. Cl. CPC G06Q 20/102; G06Q 20/42; G06Q 30/06; B60R 25/20; B60R 25/10; B60W 60/007; B60W 60/0025; B60R 2025/1016

(57) ABSTRACT

The disclosure generally pertains to systems and methods to repossess a vehicle. In an example method, a first computer sends to a second computer, a message pertaining to a notice of delinquency of a vehicle-related payment. The message includes a request to an individual, such as a purchaser or a lessee of the vehicle, to acknowledge receipt of the message. The first computer may be associated with a financing agency (a bank or a lender) and the second computer may be a vehicle computer of the vehicle or a smartphone owned by the individual. When an acknowledgement is not received within a reasonable period of time, the first computer may disable a functionality of a component of the vehicle or may place the vehicle in a lockout condition. The lockout condition may be lifted momentarily in case of an emergency to allow the vehicle to travel to a medical facility.

### BACKGROUND

An owner of a vehicle may default on a payment towards a vehicle for various reasons. The lender may send a default payment notice to the owner, followed by a notice of intent to initiate repossession proceedings if the payment is not fulfilled within a certain period of time. The owner of the vehicle may opt to disregard the notice. After additional warnings, the lender may repossess the vehicle. Typically, the owner is uncooperative at this time and may attempt to impede the repossession operation. In some cases, this can lead to confrontation.

It is therefore desirable to provide a solution to address this issue.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 shows an example system that includes a vehicle configured to support a repossession procedure in accordance with an embodiment of the disclosure.

FIG. 2 illustrates an example scenario where an individual attempts to foil a repossession procedure.

FIG. 3 illustrates an example scenario associated with an emergency that may arise when a vehicle is in a lockout condition as a part of a repossession procedure in accordance with an embodiment of the disclosure.

FIG. 4 shows some example components that may be included in a computer of a vehicle in accordance with an embodiment of the disclosure.

FIG. 5 shows some example components that may be included in a computer of a lending institution in accordance with an embodiment of the disclosure.

### DETAILED DESCRIPTION

### Overview

In terms of a general overview, certain embodiments described in this disclosure are directed to systems and methods to repossess a vehicle. In an example method, a first computer sends to a second computer, a message pertaining to a notice of delinquency of a vehicle-related payment. The message includes a request to an individual, such as a purchaser or a lessee of the vehicle, to acknowledge receipt of the message. The first computer may be associated with a financing agency (a bank or a lender) and the second computer may be a vehicle computer of the vehicle or a personal communication device belonging to the individual (a smartphone, for example). When an acknowledgement is not received within a reasonable period of time, the first computer may disable a functionality of a component of the vehicle (radio, air-conditioner, etc.) or may place the vehicle in a lockout condition. The lockout condition may be lifted momentarily in case of an emergency situation so as to allow the vehicle to travel to a medical facility when the emergency is a medical emergency. The first computer may cooperate with a vehicle computer of the vehicle, which can be an autonomous vehicle, to enable the vehicle to move to the medical facility (hospital, emergency center, etc.) or to travel to a rendezvous spot to rendezvous with an emergency vehicle (such as an ambulance, for example).

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, the word “vehicle” as used herein encompasses any of various types of automobiles. Words such as, for example, “owner,” “individual,” “occupant” and “recipient” may be used herein in an interchangeable manner and must be understood to generally refer to a person who is associated with a vehicle. For example, an “owner” of a vehicle may be a “driver” of a vehicle in some situations, or an “occupant” of the vehicle in some other situations, or a “recipient” of a message in yet some other situations. It must be understood that words such as “implementation,” “scenario,” “case,” and “situation” are to be understood as examples in accordance with the disclosure. It should be understood that the word “example” as used herein is intended to be non-exclusionary and non-limiting in nature.

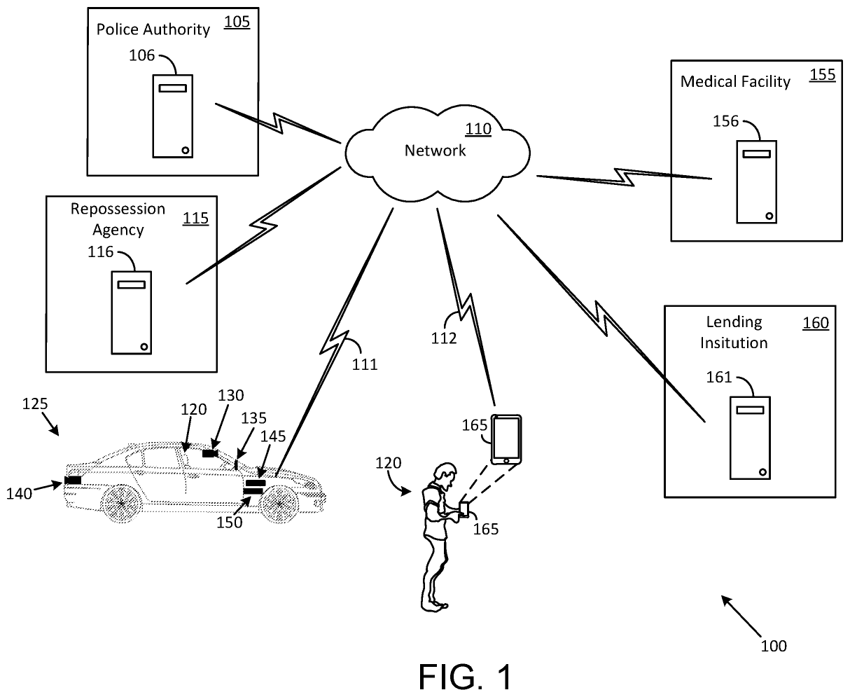

FIG. 1 shows an example system 100 that includes a vehicle 125 configured to support a repossession procedure in accordance with an embodiment of the disclosure. The vehicle 125 may be any of various types of vehicles such as, for example, a sedan, a sports utility vehicle, a truck, a van, a bus, an electric vehicle, a battery electric vehicle, a hybrid vehicle, a driver-operated vehicle, a semi-autonomous vehicle, or an autonomous vehicle. In the illustrated example, the vehicle125 can include components such as, for example, a vehicle computer 145, an infotainment system 135, a repossession system computer 150, and various sensors and detection devices that are communicatively coupled to the repossession system computer 150 and/or the vehicle computer 145.

The vehicle computer 145 may perform various functions such as controlling engine operations (fuel injection, speed control, emissions control, braking, etc.), managing climate controls (air conditioning, heating etc.), activating airbags, and issuing warnings (check engine light, bulb failure, low tire pressure, vehicle in blind spot, etc.). In some embodiments, the vehicle computer 145 may be configured to perform some, or all, functions of the repossession system computer 150.

In the illustrated scenario, the repossession system computer 150 is configured to execute various functions associated with repossession of the vehicle 125 by an entity such as, for example a financial institution, a lending institution, or an individual lender. As a part of the configuration, the repossession system computer 150 may be communicatively coupled to the vehicle computer 145 and the infotainment system 135, via wired and/or wireless connections. More particularly, in one implementation, the repossession system computer 150 is communicatively coupled to the vehicle computer 145 and the infotainment system 135 via a vehicle bus that uses a controller area network (CAN) bus protocol, a Media Oriented Systems Transport (MOST) bus protocol, and/or a CAN flexible data (CAN-FD) bus protocol. In another implementation, the communications may be provided via wireless technologies such as Bluetooth®, Ultra-Wideband, Wi-Fi, Zigbee®, or near-field-communications (NFC).

The infotainment system 135 can include a graphical user interface (GUI) or a human machine interface (HMI) that can be used to accept input from an occupant of the vehicle 125 (a driver of the vehicle 125, for example) and/or to display items such as messages, alerts, and/or notices. An example message may be sent by a lender such as, for example, a financial institution, a lending institution, or an individual lender, and may pertain to a notice of delinquency of a vehicle-related payment towards the vehicle 125.

The repossession system computer 150 may be configured to communicate via a network 110 with various computers associated with various entities, such as, for example a computer 116 of the repossession agency 115, a computer 106 of a police authority 105, a computer 156 of a medical facility 155, a computer 161 of a lending institution 160, and/or a personal communication device 165 of the owner 120.

The network 110 may include any one, or a combination of networks, such as a local area network (LAN), a wide area network (WAN), a telephone network, a cellular network, a cable network, a wireless network, and/or private/public networks such as the Internet. For example, the network 110 may support communication technologies such as Wi-Fi, Wi-Fi direct, Ultra-Wideband (UBW), machine-to-machine communication, and/or man-to-machine communication.

At least one portion of the network 110 includes a wireless communication link 111 (a WiFi link, for example), that allows the repossession system computer 150 and/or the infotainment system 135 of the vehicle 125 to communicate with the computer 116 of the repossession agency 115 and/or the computer 161 of the lending institution 160. The network 110 may also support a wireless communication link 112 (a cellular link, for example) that allows the computer 116 of the repossession agency 115 and/or the computer 161 of the lending institution 160 to communicate with a personal communication device 165 carried by the owner 120 of the vehicle 125. The personal communication device 165 can be any of various devices such as, for example, a smartphone, a tablet computer, a phablet (phone plus tablet), a wearable computer, or a laptop computer.

The repossession system computer 150 may be further configured to communicate with various objects located outside the vehicle 125 by using vehicle-to-infrastructure (V2I) communications, and with other vehicles by using vehicle-to-vehicle (V2V) communication.

The vehicle 125 may include various sensors and detection devices that are communicatively coupled to the repossession system computer 150 and/or the vehicle computer 145. A few examples of such sensors and detection devices may include a camera, an ultrasonic sensor, a radar sensor, a global positioning system (GPS) device, an infrared detector, and/or a light detection and ranging (LIDAR) device.

In the illustrated example implementation, the detection devices include a camera 130 and a camera 140. The camera 130, which can be mounted on a rear-view mirror or a dashboard of the vehicle 125, is arranged to capture images of objects located in front of the vehicle 125. The camera 140, which can be mounted on a rear bumper of the vehicle 125, is arranged to capture images of objects located behind the vehicle 125. The camera 140 and/or the camera 130 can be a digital camera that captures digital pictures or a video camera that captures video clips or produces streaming video. In some applications the camera 140 and/or the camera 130 can be a night-vision camera that captures images and/or video in low light conditions.

In an example scenario in accordance with the disclosure, the camera 130 and/or the camera 140 capture images of the walls of a garage in which the vehicle 125 may be parked, and propagate the captured images to the repossession system computer 150. The repossession system computer 150 may evaluate the images to determine whether the vehicle 125 has been parked inside a closed garage by the owner 120 of the vehicle 125 in order to foil a repossession operation of the vehicle 125.

In lieu of, or in addition to, the camera 140, an ultrasonic sensor may be mounted on the rear bumper of the vehicle 125 or on the trunk of the vehicle 125. The ultrasonic sensor would typically use ultrasonic signals to detect objects located behind the vehicle 125, and can be used day or night for detection purposes. In one scenario, the ultrasonic sensor may be coupled to the camera 140 so as to allow the camera 140 to capture images of objects at various distances from the vehicle 125.

The computer 161 of the lending institution 160 may include a database in which is stored information pertaining to financial obligations of the owner 120 of the vehicle 125. The financial obligations may pertain to a loan that may have been taken out by the owner 120 in order to purchase the vehicle 125. It must be understood that the icon depicting the lending institution 160 represents any entity such as, for example, a bank, a credit union, a money lender, or an automobile dealership that has provided a loan to the owner 120 of the vehicle 125 for purchasing, renting, or leasing the vehicle 125.

In an example scenario, the owner 120 may have purchased the vehicle 125 from an automobile dealership by using a loan provided by a bank. In another example scenario, a person may have rented the vehicle 125 from a vehicle rental agency (Hertz®, Avis®, Enterprise®, etc.) and signed a promissory note to return the vehicle 125 (after a rental period) and to pay rental fees and any penalties associated with vehicle damage, rental agreement violations, and/or delays. In yet another example scenario, a person may have leased the vehicle 125 from an automobile dealership by signing a lease agreement to return the vehicle 125 after a lease period and to pay rental fees and any penalties associated with vehicle damage and/or lease violations.

The computer 161 may also contain documents and items pertaining to legal matters with respect to situations such as the ones described above. Some example documents can include, for example, a promissory note, a loan agreement, a lease agreement, and/or a contract. The computer 161 may be configured to transfer some or all of such documents and other particulars to the computer 116 of the repossession agency 115 if the terms of the agreements have been violated and a repossession procedure has been initiated for repossessing the vehicle 125.

The repossession procedure may be typically initiated after various efforts to resolve an issue have been exhausted, because it is generally preferable to work out an arrangement to resolve the issue rather than to provoke an undesirable confrontation. A failure to make a timely payment towards the vehicle 125 may be due to various reasons such as, for example, because the owner 120 of the vehicle 125 is negligent, has suffered a job loss, or has suffered a financial setback.

In an example effort to resolve a non-payment issue, the computer 161 of the lending institution 160 may send out a first notice upon occurrence of a payment delinquency. The first notice may be sent out in the form of a message that is displayed on a display screen of the infotainment system 135 and/or on the personal communication device 165. The lending institution 160 would like to obtain legal proof that an attempt was made to contact the owner regarding the delinquent payment. Consequently, the first notice may include a request to the owner 120 of the vehicle 125 to acknowledge receipt of the message.

In an example scenario, the recipient of the message may acknowledge receipt of the message and may make an effort to address the delinquency by performing actions such as, for example, making a late payment with penalty included or contacting the lending institution 160 for setting up alternative arrangements (restructured repayment, modified payment date, loan payoff, etc.).

In another example scenario, the owner 120 of the vehicle 125 may fail to acknowledge receipt of the message. In some cases, the failure to provide an acknowledgement receipt may be due to reasons such as, for example, that the owner of the vehicle 125 is out of the country, or is medically indisposed (admitted to a hospital, for example). However, in some other cases, the owner 120 of the vehicle 125 may intentionally ignore the message and refuse to acknowledge receipt. In such cases, the computer 161 may wait for a period of time (a week, for example) and upon failing to receive an acknowledgement at the end of this period, may send out a second notice. The second notice may include a reminder and a warning that repossession proceedings will be initiated if the recipient fails to acknowledge receipt of the second message and/or the first message. In one case, the recipient may have failed to notice the first message and may acknowledge receipt of the second message and may make an effort to address the delinquency. In another case, the owner of the vehicle 125 may intentionally ignore the second message as well and refuse to acknowledge receipt of both messages.

In such cases, the computer 161 may wait for an additional period of time, (another week, for example), and upon failing to receive an acknowledgement at the end of this additional period, may communicate with the repossession system computer 150 in the vehicle 125 to initiate execution of a multi-step repossession procedure in accordance with the disclosure.

The first step of the multi-step repossession procedure may involve the computer 161 instructing the repossession system computer 150 to disable a functionality of one or more components of the vehicle 125. In an example embodiment in accordance with the disclosure, the repossession system computer 150 may perform this operation based on associating various components in the vehicle 125 with various categories. In an example implementation, the categories can include a primary-use component category, a first level optional-use component, a second level optional-use component, and so on.

Some components belonging to the primary-use component category may include, for example, the engine, the brake, the accelerator, the steering wheel, the doors, and lights of the vehicle 125.

Some components belonging to the first level optional-use component category may include, for example, cruise control, automated window controls, automated seat controls, and some components of the infotainment system 135 (radio, global positioning system (GPS), MP3 player, etc.). Disabling such components may cause a certain level of discomfort to a driver and occupants of the vehicle 125.

Some components belonging to the second level optional-use component category may include, for example, the air conditioning system, a remote key fob, and an automated door lock/unlock system. Disabling such components may cause an additional level of discomfort to a driver and occupants of the vehicle 125.

In an example embodiment in accordance with disclosure, the repossession system computer 150 may execute the first step of the multi-step repossession procedure by disabling some or all components belonging to the first level optional-use component category for a first period of time (a few days, for example). The repossession system computer 150 may carry out the disabling operation either independently, or in cooperation with the vehicle computer 145.

If the owner of the vehicle 125 fails to respond to the notice of delinquency over the first period of time, the repossession system computer 150 may then disable some or all components belonging to the second level optional-use component category for a second period of time (same, or different than, the first period of time). The procedure may be repeated for the other optional-use component categories (if such categories are present).

In another example embodiment in accordance with disclosure, the repossession system computer 150 may execute the first step of the multi-step repossession procedure by activating an audio component in the vehicle 125 (such as, for example, a radio, a beeper, or a chime). Activating the audio component can involve configuring the audio component to emit an incessant and unpleasant sound every time the owner 120 is present in the vehicle 125. The repossession system computer 150 may control various attributes of the sound in order to make the sound unpleasant, such as, for example, by varying a tone, a timber, a pitch, a cadence, a beat, or a volume of the sound. The repossession system computer 150 may also ensure that the owner 120 is unable to turn off the sound without first making contact with the lending institution 160 to address the payment delinquency.

If the owner of the vehicle 125 still fails to respond to the notice of delinquency over the second period of time and/or in spite of the sound produced by the chime, the repossession system computer 150 may provide a final warning and disable some or all components belonging to the primary-use component category. In an example scenario, the repossession system computer 150 may disable the door lock mechanism, thereby placing the vehicle 125 in a lockout condition and preventing a person from entering a cabin of the vehicle 125.

The lockout condition may be enforced in a modified form in some situations. In one example situation, the repossession system computer 150 may enforce the lockout condition only during weekends and to allow use of the vehicle 125 during weekdays. Allowing use of the vehicle 125 during weekdays avoids adversely affecting a livelihood of the owner of the vehicle 125 and hampering the owner's ability to make payments towards the vehicle 125. In another example situation, the repossession system computer 150 may define a geofence around a residence of the owner and allow limited use of the vehicle 125 inside the geofence. In some cases, repossession system computer 150 may permit travel within the geofence only during certain days and/or during certain times of a day. The owner may use the vehicle 125 to travel inside the geofence at these times for certain activities such as, for example, to purchase groceries or to drop off a child at school. No travel is permitted outside the geofence.

In yet another example situation, the repossession system computer 150 may avoid endangering safety and health of the owner 120 and other people associated with the vehicle 125, when the vehicle 125 has been placed in the lockout condition. In an example scenario directed at avoiding health hazards, the repossession system computer 150 may evaluate images provided by one or more cameras of the vehicle 125 in order to detect an emergency (e.g., a medical emergency situation) such as, for example, a driver of the vehicle 125 suffering a heart attack. If such an emergency situation were to arise, the repossession system computer 150 may immediately communicate with the computer 156 of the medical facility 155 to dispatch medical assistance to aid the person involved in the emergency situation.

The repossession system computer 150 may execute certain additional actions after imposing a lockout condition upon the vehicle 125 (in normal form or in modified form). Such actions may include, for example, configuring the camera 130 and/or the camera 140 to capture images of the surroundings of the vehicle 125 (execute video recording in real-time, for example) and evaluating the captured images to identify undesirable actions that the owner of the vehicle 125 may take in response to the lockout condition.

In a first case, the owner of the vehicle 125 may detect the lockout condition and contact the lending institution 160 to address the payment delinquency. In a second case, the owner of the vehicle 125 may take no action towards resolving the issue. In a third case, the owner of the vehicle 125 may take steps to block repossession of the vehicle 125 and/or may damage the vehicle 125.

In the first case, the repossession system computer 150 may lift the lockout if the owner contacts the lending institution 160 and resolves the payment delinquency.

In the second case, where the owner takes no action towards resolving the issue, the repossession system computer 150 may wait for a period of time (a few days, for example) and then proceed to execute the next step of the multi-step repossession procedure. In one example scenario, the next step of the multi-step repossession procedure can involve the repossession system computer 150 sending a directive to the computer 116 in the repossession agency 115 to initiate repossession actions. The repossession agency 115 may proceed with action such as, for example, contacting the owner 120 of the vehicle 125 (either over the phone or by arranging for an agent of the repossession agency 115 to visit the owner 120 of the vehicle 125).

If these actions do not resolve the payment delinquency issue, the repossession agency 115 may make arrangements to impound the vehicle 125 (such as, for example, by dispatching a tow truck to tow the vehicle 125). In some cases, the vehicle 125 can be a semi-autonomous vehicle and the repossession system computer 150 may cooperate with the vehicle computer 145 in the semi-autonomous vehicle to autonomously move the vehicle 125 from a first spot to a second spot that is more convenient for a tow truck to tow the vehicle 125. The first spot may, for example, be located inside the property line of the owner 120 (a garage or a driveway, for example) and the second spot may be outside the property line (a public road, for example).

In some other cases, the vehicle 125 can be an autonomous vehicle and the repossession system computer 150 may cooperate with the vehicle computer 145 to autonomously move the vehicle 125 from the premises of the owner 120 to a location such as, for example, the premises of the repossession agency 115, the premises of the lending institution 160, an impound pound, or any other pre-designated location. The address of such locations may be previously stored in a database of the repossession system computer 150.

In yet some other cases, the repossession system computer 150 may communicate with the computer 161 of the lending institution 160 to identify a market value of the vehicle 125. The computer 161 of the lending institution 160 and/or the repossession system computer 150 may then compare the market value of the vehicle 125 against a pre-determined threshold price in order to evaluate a financial viability of executing a repossession procedure. The pre-determined threshold price can be based on various factors such as, for example, a mileage of the vehicle 125, a physical condition of the vehicle 125, and/or certain costs associated with repossession (towing, storage, re-sale proceedings etc.). If the market value of the vehicle 125 is below the pre-determined threshold price, the repossession system computer 150 may cooperate with the vehicle computer 145 to autonomously move the vehicle 125 from the premises of the owner 120 to a junkyard.

In a third case, where the owner of the vehicle 125 has taken steps to block repossession of the vehicle 125, the repossession system computer 150 may detect the action by evaluating images provided by cameras, for example, and may transmit a complaint to the computer 106 associated with the police authority 105. The police authority 105 may respond to the complaint by taking actions such as, for example, contacting the owner 120 of the vehicle 125 either over the phone or by arranging for a police officer to visit the owner 120 of the vehicle 125.

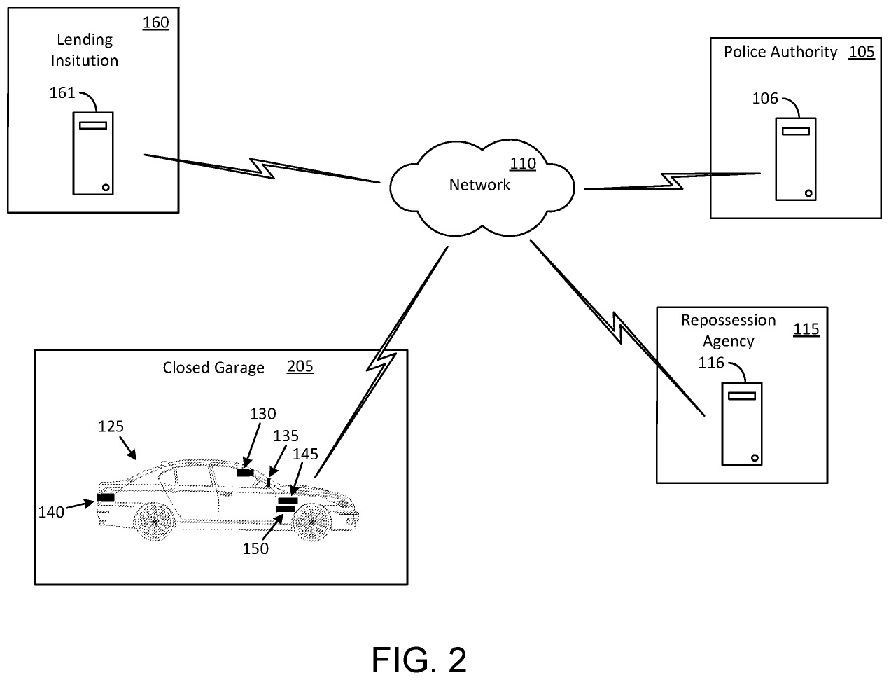

FIG. 2 illustrates an example scenario where the owner 120 of the vehicle 125 attempts to foil a repossession procedure by parking the vehicle 125 inside a closed garage 205. The repossession system computer 150 may detect the parking of the vehicle 125 inside the garage 205 based on evaluating images received from the camera 130 and/or the camera 140. The images may include views of the inside of the garage 205 (walls, door, etc.). The repossession system computer 150 may communicate with the computer 161 of the lending institution 160 to inform the lending institution 160 of the situation and to request instructions on how to proceed. The computer 161 of the lending institution 160 may verify that the owner 120 has not made a vehicle-related payment on time and certain actions have to be taken such as, for example, initiating repossession procedures and/or communicating with the computer 106 of the police authority 105 to request the police to take action.

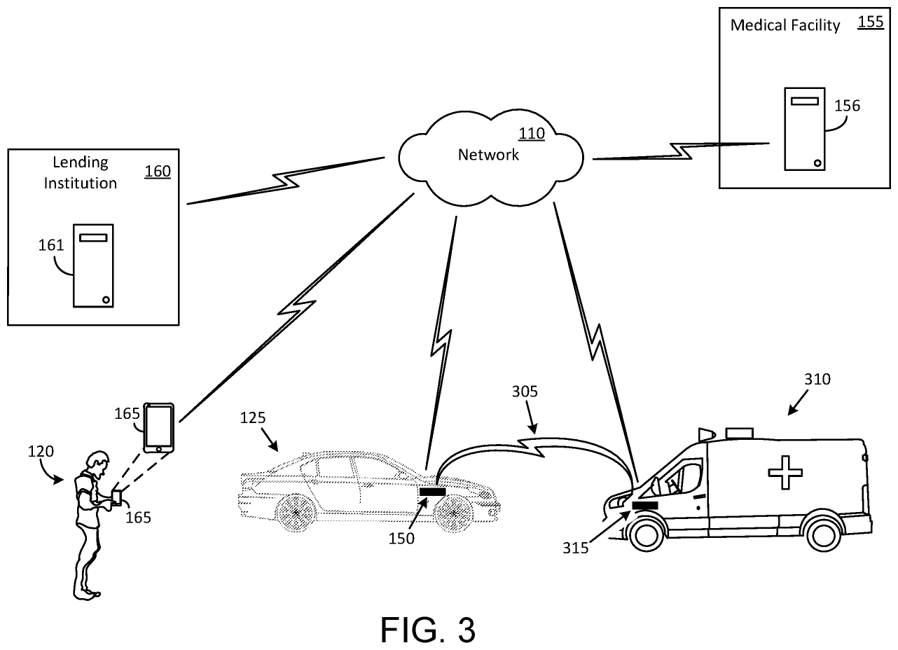

FIG. 3 illustrates an example scenario associated with an emergency that may arise when the vehicle 125 has been placed in a lockout condition. In this example scenario, the vehicle 125 is a driver-operated vehicle and a family member of the owner 120 of the vehicle 125 has suffered a medical emergency (a heart attack, for example) that requires immediate medical attention. The owner 120 may use his/her personal communication device 165 to communicate with the repossession system computer 150 and request that the lockout condition be lifted so as to permit use the vehicle 125 to travel to a hospital or an emergency care facility.

The repossession system computer 150 may respond to the request made by the owner 120 by temporarily lifting the lockout condition for a period of time. The period of time may be based on various factors such as, for example, a severity of the medical emergency, a preset period (two days, for example), negotiations between the owner 120 and personnel at the lending institution 160, and or by receiving information from the computer 156 of the medical facility about a resolution of the medical emergency.

The lockout condition may be reimposed after expiry of the period of time and if the payment delinquency remains unresolved. In one case, the repossession system computer 150 may send one or more messages to the owner 120 before reimposing the lockout condition so as to warn the owner 120 of the reimposing of the lockout condition.

The repossession system computer 150 may further respond to the request made by the owner 120 by sending an alert to the computer 156 of the medical facility 155, followed by accessing a database provided in the repossession system computer 150 (or in another computer located elsewhere) to identify an address of the closest hospital or emergency care facility (the medical facility 155, in this example scenario). In one case, the repossession system computer 150 may then automatically configure a GPS device in the vehicle 125 to assist the owner 120 travel to the medical facility 155 as quickly as possible.

In another example scenario, where the vehicle 125 is an autonomous vehicle, the repossession system computer 150 may cooperate with the vehicle computer 145 to enable the vehicle 125 to autonomously travel to the medical facility 155 (hospital, emergency center, etc.) or to travel to a rendezvous spot to rendezvous with an emergency vehicle 310 (such as an ambulance, for example). The rendezvous with the emergency vehicle 310 may be facilitated by vehicle-to-vehicle (V2V) communications between the repossession system computer 150 and a computer 315 of the emergency vehicle 310, or by wireless communications carried out via the network 110. The V2V communications may be conducted over a wireless link 305 and arrangements may be made to rendezvous with the emergency vehicle 310 at a rendezvous spot where personnel from the emergency vehicle 310 can provide emergency treatment and can transport the person suffering from a medical condition (e.g., from a heart attack) to the medical facility 155.

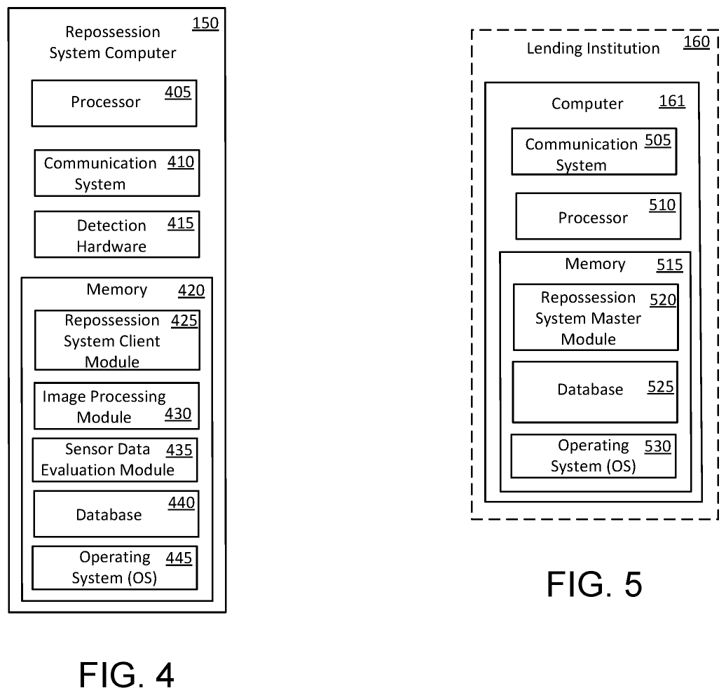

FIG. 4 shows some example components that may be included in the repossession system computer 150 provided in the vehicle 125 in accordance with an embodiment of the disclosure. Some or all parts of the repossession system computer 150 may be included in the vehicle computer 145. In this example implementation, the repossession system computer 150 includes a processor 405, a communication system 410, detection hardware 415, and a memory 420. The communication system 410 can include a wireless transceiver that allows the repossession system computer 150 to communicate with various devices such as, for example, the computer 161 in the lending institution 160, the computer 106 of the police authority, the computer 116 of the repossession agency 115, the computer 156 of the medical facility 155, the computer 315 in the emergency vehicle 310, the personal communication device 165 of the owner 120, and the computer 315 in the emergency vehicle 310. The wireless transceiver may use any of various communication formats such as, for example, an Internet communications format, a cellular communications format, a vehicle-to-vehicle (V2V) communication format, and/or a vehicle-to-everything (V2X) communication format to communicate with the various devices.

The wireless transceiver of the communication system 410 may also use one or more of various wireless technologies such as Bluetooth®, Ultra-Wideband (UWB), Wi-Fi, ZigBee®, Li-Fi (light-based communication), audible communication, ultrasonic communication, or near-field-communications (NFC), for carrying out wireless communications with devices such as the personal communication device 165 of the owner 120 and/or the infotainment system 135 of the vehicle 125.

The communication system 410 may also include circuitry for receiving information (signals, images, etc.) from various devices in the vehicle 125, such as, for example, the camera 130, the camera 140, and/or various sensors.

The detection hardware 415 can include various sensors and detection devices such as, for example, a camera, an ultrasonic sensor, a radar sensor, a global positioning system (GPS) device, an infrared detector, and a light detection and ranging (LIDAR) device.

The memory 420, which is one example of a non-transitory computer-readable medium, may be used to store an operating system (OS) 445, a database 440, and code modules such as a repossession system client module 425, an image processing module 430, and a sensor data evaluation module 435. The code modules are provided in the form of computer-executable instructions that can be executed by the processor 405 for performing various operations in accordance with the disclosure.

The database 440 may be used to store various types of information such as, for example, financial information associated with a purchase, a lease, or a rental of the vehicle 125, a schedule for vehicle-related payments (such as, for example, payment due date each month), payment delinquencies, and/or information such as, for example, address and contact information of the lending institution 160, the repossession agency 115, the police authority 105, and/or the medical facility 155.

The repossession system client module 425 can include code for executing various actions in accordance with the disclosure. In some scenarios, the repossession system client module 425 may utilize the image processing module 430 and/or the sensor data evaluation module 435 to process information provided to the repossession system computer 150 by various devices such as, for example, the camera 130, and/or the camera 140. Various image processing techniques may be used for processing images provided by the camera. In an example implementation, the image processing module 430 may incorporate an image processing algorithm modeled on a neural network that is trained to analyze images of various objects and detect, for example, a closed status of a garage and/or a medical emergency situation (owner 120 suffering a heart attack, for example). In some embodiments, reference images stored in the database 440, and/or fetched from a device such as the computer 161 of the lending institution 160, may be used by the image processing module 430 for evaluating images provided by the camera 130 and the camera 140.

FIG. 5 shows some example components that may be included in the computer 161 of the lending institution 160 in accordance with an embodiment of the disclosure. In this example implementation, the computer 161 includes a communication system 505, a processor 510, and a memory 515. The communication system 505 can include a wireless transceiver that allows the computer 161 to communicate via the network 110 with various devices such as the repossession system computer 150 in the vehicle 125. The wireless transceiver may use any of various communication formats such as, for example, an Internet communications format or a cellular communications format for communicating with the various devices.

The memory 515, which is another example of a non-transitory computer-readable medium, may be used to store an operating system (OS) 530, a database 525, and code modules such as a repossession system master module 520. The code modules are provided in the form of computer-executable instructions that can be executed by the processor 510 for performing various operations in accordance with the disclosure.

The database 525 may be used to store various types of information such as, for example, financial information associated with purchase, lease, or rent of various vehicles by various individuals, schedules for vehicle-related payments by the various individuals, payment delinquencies, and/or information such as, for example, address and contact information of the various individuals.

The repossession system master module 520 can include code for executing various actions in accordance with the disclosure, such as the example actions described above. In an example implementation, the repossession system master module 520 executes actions such as, for example, sending messages and warnings related to delinquent payments to computers in various vehicles (such as, for example, the repossession system computer 150 in the vehicle 125), sending lockout commands to computers in various vehicles, sending out temporary unlock commands to computers in various vehicles, communicating with the repossession agency 115 to provide instructions to repossess a vehicle, and/or arranging a rendezvous between two vehicles (such as the vehicle 125 and the emergency vehicle 310).

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” or “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, such as the processor 405 or the processor 510, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device such as the memory 420 or the memory 515, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not in function.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
sending, by a first processor to a second processor, a first message comprising a notice of delinquency of a vehicle-related payment towards a vehicle, the first message further comprising a request to acknowledge receipt of the first message;
detecting, by the first processor, a failure to receive the acknowledgement; and
disabling, by the first processor, a functionality of a first component of the vehicle in response to detecting the failure to receive the acknowledgement.

2. The method of claim 1, further comprising:
detecting, by the first processor, a placement of the vehicle in a condition that prevents repossession of the vehicle; and
placing, by the first processor, the vehicle in a lockout condition that prevents an individual from entering a cabin of the vehicle.

3. The method of claim 2, wherein placing the vehicle in the condition that prevents repossession of the vehicle comprises parking the vehicle inside a locked garage.

4. The method of claim 2, further comprising:
receiving, by the first processor, a request to unlock the vehicle in view of an emergency situation; and
lifting, by the first processor, the lockout condition for a first period of time to allow operating of the vehicle in view of the emergency situation.

5. The method of claim 4, wherein the vehicle is an autonomous vehicle and wherein the method further comprises the autonomous vehicle autonomously traveling to a rendezvous spot with an emergency vehicle or to a medical facility.

6. The method of claim 4, further comprising:
sending, by the first processor to the second processor, after expiry of the first period of time, a second message that includes a warning of an upcoming lockout of the vehicle if the vehicle-related payment is not made within a second period of time; and
placing, by the first processor, the vehicle in the lockout condition upon detecting a non-payment of the vehicle-related payment within the second period of time.

7. The method of claim 1, further comprising:
configuring, by the first processor, an audio component and/or a chime in the vehicle to emit an incessant and unpleasant sound until one of an acknowledgement is received from an individual who is associated with the vehicle or until the vehicle-related payment is made.

8. A method comprising:
sending, by a first processor to a second processor, a first message comprising a notice of delinquency of a vehicle-related payment towards a vehicle, the first message further comprising a request to acknowledge receipt of the first message by an individual who is associated with the vehicle;
detecting, by the first processor, a failure to receive an acknowledgement receipt of the first message from the individual;
sending, by the first processor, to the second processor, a second message comprising a reminder to acknowledge receipt of the first message; and
placing, by the first processor, the vehicle in a lockout condition in response to detecting the failure to receive the acknowledgement receipt of the first message from the individual.

9. The method of claim 8, further comprising:
receiving, by the first processor, a request to unlock the vehicle in view of an emergency situation; and
lifting, by the first processor, the lockout condition for a first period of time to allow operating of the vehicle in view of the emergency situation.

10. The method of claim 9, wherein the vehicle is an autonomous vehicle and wherein the method further comprises the autonomous vehicle autonomously traveling to a rendezvous spot with an emergency vehicle or to a medical facility.

11. The method of claim 9, further comprising:
sending, by the first processor to the second processor, after expiry of the first period of time, a third message that includes a warning of an upcoming lockout of the vehicle if the vehicle-related payment is not made within a second period of time; and
placing, by the first processor, the vehicle in the lockout condition again upon detecting a non-payment of the vehicle-related payment within the second period of time.

12. The method of claim 8, further comprising:
configuring, by the first processor, an audio component and/or a chime in the vehicle to emit an incessant sound until one of an acknowledgement is received from the individual who is associated with the vehicle or until the vehicle-related payment is made.

13. The method of claim 8, further comprising:
detecting, by the first processor, a placement of the vehicle in a condition that prevents repossession of the vehicle; and
sending, by the first processor, to a repossession agency, a directive to repossess the vehicle, in response to the placement of the vehicle in the condition that prevents repossession.

14. The method of claim 8, wherein the vehicle is an autonomous vehicle and wherein the method further comprises:
detecting, by the first processor, a failure to receive the vehicle-related payment within a first period of time; and
sending, by the first processor, to the autonomous vehicle, a command to travel to a vehicle repossession site.

15. A system comprising:
a vehicle;
a first computer; and
a second computer, the second computer comprising:
a memory that stores computer-executable instructions; and
a processor configured to access the memory and execute the computer-executable instructions to perform operations comprising:
sending, to the first computer, a first message comprising a notice of delinquency of a vehicle-related payment towards the vehicle, the first message further comprising a request to acknowledge receipt of the first message;
detecting a failure to receive the acknowledgement; and
disabling a functionality of a first component of the vehicle in response to detecting the failure to receive the acknowledgement.

16. The system of claim 15, wherein the first computer is one of located in the vehicle or possessed by an individual who is associated with the vehicle, and wherein the processor of the second computer is further configured to access the memory and execute additional computer-executable instructions to perform operations comprising:
detecting a placement of the vehicle in a condition that prevents repossession of the vehicle; and
placing the vehicle in a lockout condition that prevents the individual from entering a cabin of the vehicle.

17. The system of claim 16, wherein the processor of the second computer is further configured to access the memory and execute additional computer-executable instructions to perform operations comprising:
receiving a request to unlock the vehicle in view of an emergency situation; and
lifting the lockout condition for a first period of time to allow operating of the vehicle in view of the emergency situation.

18. The system of claim 17, wherein the vehicle is an autonomous vehicle, and wherein the processor of the second computer is further configured to access the memory and execute additional computer-executable instructions to perform operations comprising:
send a command to the autonomous vehicle to travel to a rendezvous spot with an emergency vehicle or to a medical facility.

19. The system of claim 17, wherein the processor of the second computer is further configured to access the memory and execute additional computer-executable instructions to perform operations comprising:
sending, to the second computer, after expiry of the first period of time, a second message that includes a warning of an upcoming lockout of the vehicle if the vehicle-related payment is not made within a second period of time; and
placing the vehicle in the lockout condition upon detecting a non-payment of the vehicle-related payment within the second period of time.

20. The system of claim 19, wherein the vehicle is an autonomous vehicle, and wherein the processor of the second computer is further configured to access the memory and execute additional computer-executable instructions to perform operations comprising:
send a command to the autonomous vehicle to travel to a vehicle repossession site.
